(19) United States
(12) Patent Application Publication
(10) Pub. No.: US 2014/0021193 A1
(43) Pub. Date: Jan. 23, 2014

(54) HEATING MODULE

(71) Applicants: SHU-CHIEN CHAO, Taipei City (TW); YUN-JOU CHANG, Taipei City (TW)

(72) Inventors: SHU-CHIEN CHAO, Taipei City (TW); YUN-JOU CHANG, Taipei City (TW)

(21) Appl. No.: 13/550,623

(22) Filed: Jul. 17, 2012

(51) Int. Cl. H05B 3/04; H05B 3/06; H05B 1/02; H05B 3/34

(52) U.S. Cl. 219/494; 219/528; 219/531; 219/533; 219/536

(57) ABSTRACT

The present invention provides a heating module attachable to an external object, comprising a heat insulation layer, at least one heat generating layer and a heat conductive layer. The heat generating layer is provided between the heat insulation layer and the heat conductive layer, and the heat generating layer is attached to a waterproof power connector box provided for ensuring a safe connection therebetween such that the heat from the heat generating layer generates can be controlled via the controller by users. As the heat conductive layer of the heating module is attached to the external object, the heat generated by the heat generating layer is transferred to the heat conductive, capable of uniformly distributing the heat further to the object, including such as floor, wall, outdoor roof and others, and such that the surface temperature of the object is maintained and the room temperature in the surrounding is increased.

### (A) TECHNICAL FIELD OF THE INVENTION

The present invention is related to a heating module, in particular, to a heating module attachable to an external object such that heat can be uniformly distributed from the heating module to the external object to maintain the surface temperature of the object and to further increase the room temperature in the surrounding.

### (B) DESCRIPTION OF THE PRIOR ART

Due to the climate changes on earth, global temperatures are of greater extremes in terms of the degree of cold and hot temperatures associated with these climate changes. In places such as tropical areas where snow falls and cold weathers are rare, it has been shown that in recent years, there have been snow stores appearing in these areas. Common heating equipment and gear designed for normal conditions are found to be insufficient, and in situations where cold weathers or currents take place and the room temperatures drop dramatically, portable heaters, electric heaters and other types of heaters become of greater importance and are being widely used to prevent cold and temperature drops.

Traditional heating equipment such as community heater utilizing the heat generated from the burning of coal tends to cause air pollution in relation to the concerns of global warming and to reduction of carbon dioxide. Geothermal heating and other replaceable energy conversion heating plants typically incur a significant amount of costs invested in the planning and constructing of the plant and machinery, which are undesirable economically. As for a known electric heater, it typically comprises a heating element and is of a structure similar to an electric fan or fireplace stove that tends to be of a large volume and is inconvenient in terms of its portability and storage for seasonal uses. Furthermore, most known heaters are built or designed to their heating elements being exposed externally, which can cause potential hazards to users, especially to children and elders, in living areas where such heaters are placed or in use.

### SUMMARY OF THE INVENTION

In view of the abovementioned drawbacks of known heaters, the present invention provides a heating module comprising a heat insulation layer, at least one heat generating layer and a heat conductive layer. The heat generating layer is provided on a top surface of the heat insulation layer and is attached to a waterproof power connector box ensuring the heating material and the power being safely connected with each other and providing an insulated shell with waterproof and pressure resistance protections such that the a solid and reliable safety mechanism can still be provided for connection parts or components subject to outdoor environment or conditions of snow falling and melting. The waterproof power connector box further comprises a power controller connecting end or port attached to an external power source in addition to a temperature controller. The temperature controller is able to control the temperature and the time of usage of the heat generated by the heat generating layer. The heat conductive layer is provided on top of the heat generating layer such that the heat generating layer is arranged or positioned relatively between the heat conductive layer and the heat insulation layer. With such configuration and arrangement, the heating module attachable to an external object can be attached to a surface of the external object such that the heat from the heat generating layer thereof can be conductively transferred to the heat conductive layer and further to the external object uniformly. The heat conductive layer is able to uniformly transfer the heat and to distribute the heat over the external object such that the heat is uniformly distributed to the external object including such as floor, wall, mirror, stone, metal, plastics, silicon gels and carpets and such that the surface of the object is maintained at a certain temperature and the environmental or room temperature in the surrounding of the object can be increased.

### BRIEF DESCRIPTION OF THE DRAWINGS

FIG. 1 is an exploded view of a first embodiment of the heating module of the present invention;

FIG. 2 is a cross sectional view of the assembly of the first embodiment of the heating module of the present invention;

FIG. 3 is an exploded view of a second embodiment of the heating module of the present invention;

FIG. 4 is an assembly view of the second embodiment of the heating module of the present invention;

FIG. 5 is an exploded view of the waterproof power connector box of the heating module of the present invention;

FIG. 6 is an illustration showing the waterproof power connector box of the heating module of the present invention;

FIG. 7 is an illustration showing a first exemplary embodiment of the heating module of the present invention in an application of use;

FIG. 8 is an illustration showing a second exemplary embodiment of the heating module of the present invention in another application of use;

FIG. 9 is an illustration showing a third exemplary embodiment of the heating module of the present invention in another application of use;

FIG. 10 is an illustration showing a fourth exemplary embodiment of the heating module of the present invention in another application of use; and

FIG. 11 is an illustration showing a fifth exemplary embodiment of the heating module of the present invention in another application of use.

### DETAILED DESCRIPTION OF THE PREFERRED EMBODIMENTS

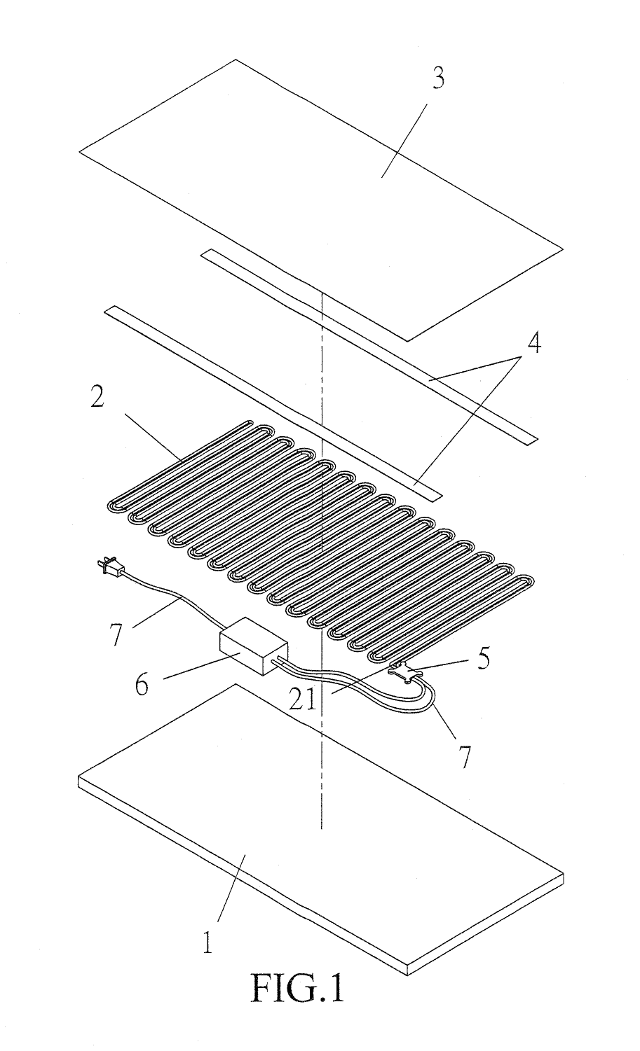

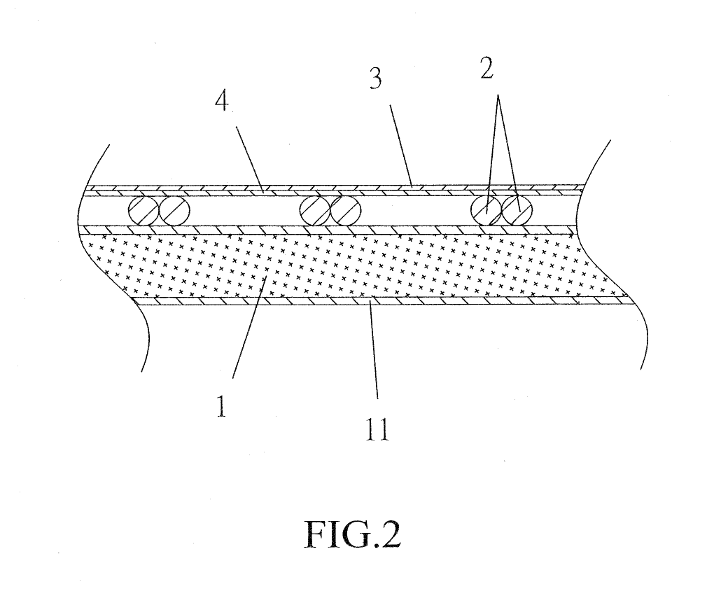

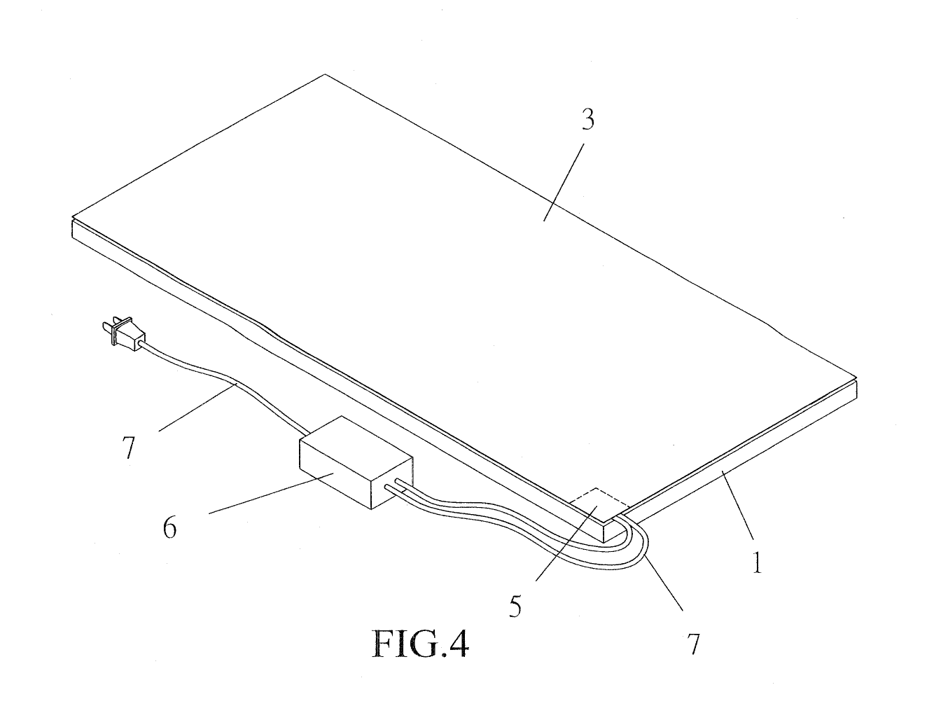

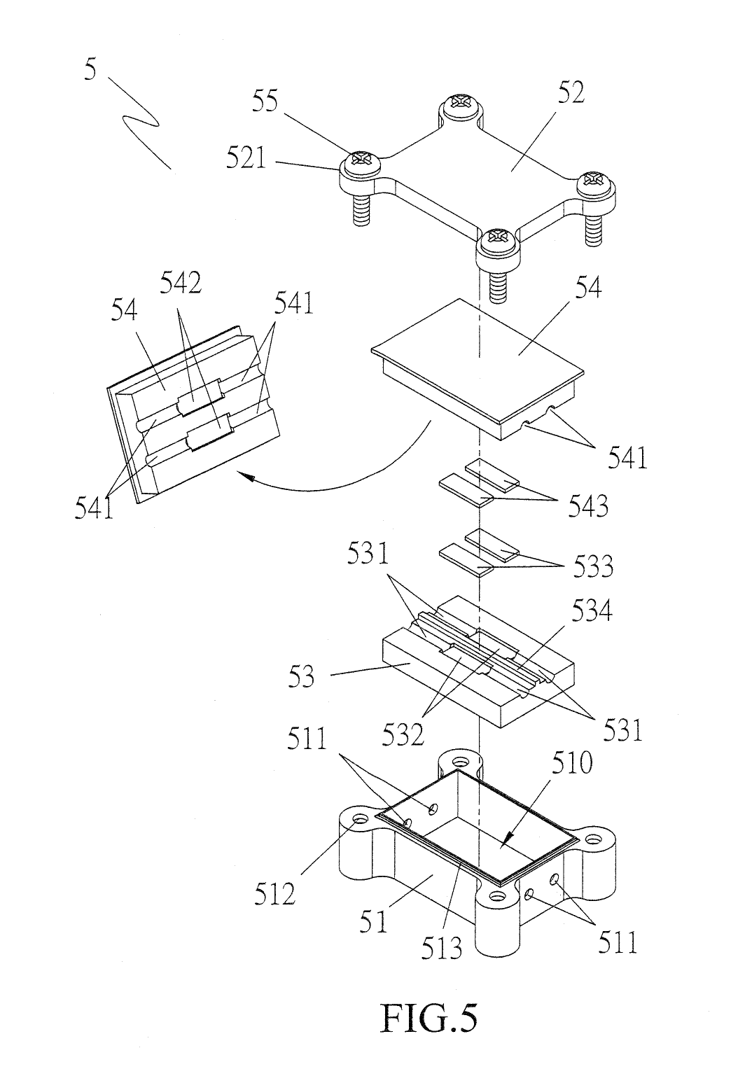

As shown in FIGS. 1, 2, 3, 4 and 5, the present invention provides a flexible heating module, in particular, a heating module attachable to an external object 8. Said heating module comprises a heat insulation layer 1, at least one heat generating layer 2, a heat conductive layer 3, at least two securing means 4, a waterproof power connector box 5 and a temperature controller 6.

The heat insulation layer 1 is made of heat insulation materials and is provided or positioned at a bottom layer of the heating module of the present invention. As exemplarily demonstrated by an embodiment of the present invention, the heat insulation material consists of knitted wool fibers enclosed by an aluminum foil; or said heat insulation material can be made of any one of the following of a fabric made of glass fibers, ceramic fibers, expanded polystyrene insulation layer, asbestos, insulation paints, heat-resistance fabrics, high density foam or heat-resistance plate. Furthermore, the heat insulation material of the heat insulation layer 1 can be of a soft material, including such as fabrics of glass fibers, ceramic fibers or heat-resistance fabrics, such that the heat insulation layer 1 exhibits flexibility in the property thereof.

The heat generating layer 2 is provided or arranged on a top surface of the heat insulation layer 1 and the heat generating layer 2 comprises a heating wire port 21; said heating wire port 21 can be further attached to an external power such that the heat generating layer 2 can generate heat. In an exemplary embodiment of the present invention, the heat generating layer 2 can be made of carbon fibers with heating wires enclosing an insulation material. Furthermore, the heat generating layer 2 can too be of flexibility and be made of a heat generating material capable of producing or generating heat upon electrical connections, including such as heating electrical wires, heating copper wires, graphite fibers with heating wires, metallic fibers or carbon fibers with heating films. The heat generating layer 2 can also be non-flexible with a heat generating material capable of producing or generating heat upon electrical connections, including such as infrared heating pipes.

The heat conductive layer 3 is provided or arranged on top of the heat generating layer 2 such that the heat generating layer 2 is relatively positioned between the heat conductive layer 3 and the heat insulation layer 1. In an exemplary embodiment of the present invention, the heat conductive layer 3 is made of a heat conductive material and a bottom part of the heat conductive layer 3 is coated with a heat dissipating paste or glue such that the heat conductive layer 3 can be seamlessly attached to the heat generating layer 2 to achieve the effective transferring of the heat generated by the heat generating layer 2 to the heat conductive layer 3. The abovementioned heat conductive material can be one of the following of glass fiber fabrics, heat conductive silicon glue, heat conductive carbon film, celluloid, cellulose acetate plastic, polyester fibers; said heat dissipating paste can be one of the following of a heat dissipating gel, heat conductive paints or heat conductive silicon paste.

The securing means 4 consists of an aluminum tape, heat-resistance glass fiber tape and heat-resistance paste agent. The securing means 4 is provided between the heat generating layer 2 and the heat conductive layer 3 such that the heat generating layer 2 is secured onto the top surface of the heat insulation layer 1 via the securing means 4.

The waterproof power connector box 5 is provided to overcome the drawbacks in conventional connector boxes in which the heating wire port 21 (heating fibers) and the power line connecting to conventional ports thereof tend to be snapped or broken due to external pulling, causing electrical mal-connections and without waterproof functionalities. The present invention, on the other hand, provides an improved structure by having the fragile heating wire port 21 (heating fibers) and the conductors of the power line being enclosed or covered for electrical connections, and the heating wire port 21 and the external power line 7 are secured or hold in place by utilizing the waterproof connector box 5 to secure or hold the insulation outer covering skin thereof such that an excellent securement and protection mechanism can be provided and achieved. The waterproof connector box 5 further includes the functionality of waterproof insulation such that it can be used for constant temperature heating in outdoor environments of for example, applications related to snow melting or swimming pool.

In addition to the above, the heating module of the present invention can be of a configuration of a module such that the heating module can be attached or combined with an external object 8. The heat conductive layer 3 of the heating module can be attached to a surface of the external object 8 such that the heat generated by the heat generating layer 2 can be transferred to the heat conductive layer 3 and the heat conductive layer 3 is able to uniformly distributed the heat to the external object 8 such that the heat is evenly or uniformly distributed on the object 8 including such as floor, wall, mirror or carpet, allowing the surface of the object 8 to be maintained at a certain temperature. Furthermore, the outer part of the heat insulation layer 1 can be covered or enclosed by an aluminum foil 11 such that the heat generated by the heat generating layer 2 can be reflected by the aluminum foil 11 of the heat insulation layer 1 to achieve the effect of gathering and transferring the heat generated by the heat generating layer 2 upward to the heat conductive layer 3.

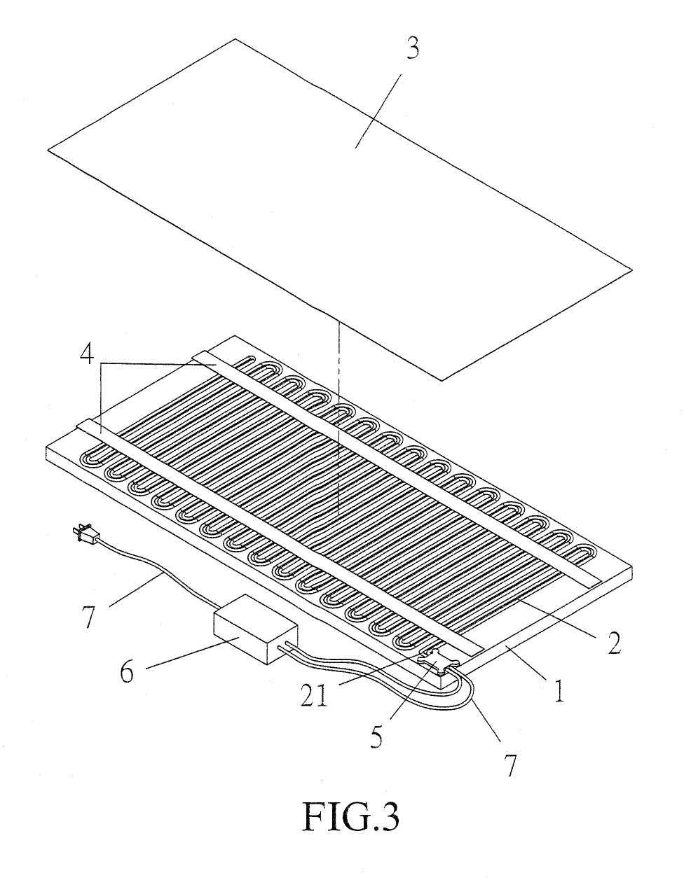

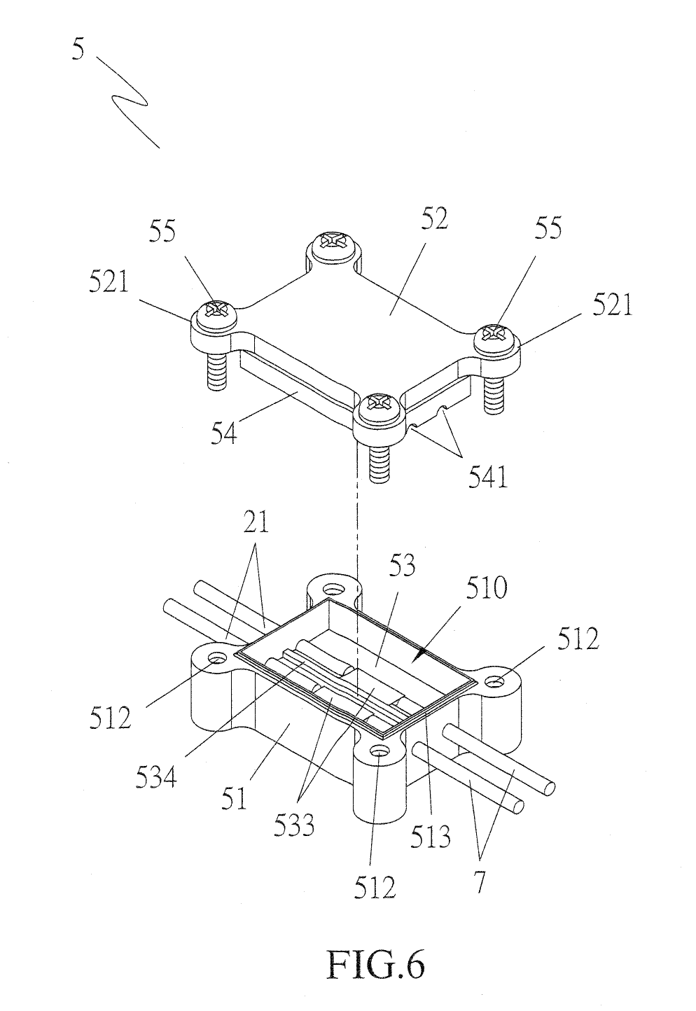

Furthermore, the present invention further provides another exemplary embodiment of a heating module, as shown in FIGS. 3, 4, 5 and 6. Said heating module further comprises a waterproof power connector box 5 and a temperature controller 2. The heating wire port 21 of the heat generating layer 2 is electrically connected to an external power line 7 via the waterproof connector box 5 in order to provide the external power to the heat generating layer 2. In addition, the external power line 7 can be further electrically connected to the temperature controller 6 to achieve the effect of having the temperature controller 6 controlling the heat generating layer 2 to generate heat in accordance with a predetermined temperature. Said waterproof power connector box 5 comprises a base 51, a cover 52, a first attachment means 53 and a second attachment means 54. The base 51 comprises a receiving space 510, at least two through holes 511 respectively provided on two parallel side walls of the base 51 and opposing to each other and at least four fixations 512 provided on the base 51, and a top portion of the base 51 is also provided with a waterproof strip 513. The cover 52 is attached to and sealed on the top portion of the base 51, and the cover 52 comprises at least four fixations 521 corresponding to said fixations 512 of the base 51. By fastening the cover 52 and the base 51 via fasteners 55, such as screws, and as the cover 52 and the base 51 are fastened altogether with each other, the cover 52 is being pressed firmly onto the waterproof strip 513 such that the cover 52 and the base 51 are attached and sealed to each other. The first attachment means 53 is received within the receiving space 510 of the base 51, and a surface of said first attachment means 53 comprises two first slots 531 and first grooves 532 spaced apart from each other. The first groove 532 is configured on a path of the first slot 531; and a first conductive plate 533 is received within said first groove 532. In addition, a positive and negative electrode separation strip 534 is further provided between the two first slots 531 of the first attachment means 53. The second attachment means 54 is received within the receiving space 510 of the base 51 and covers the surface of the first attachment means 53, and a bottom surface of said second attachment means 54 comprises two second slot 541 and second groove 542 spaced apart from each other; said second slots 541 and second grooves 542 are arranged corresponding to said first slots 531 and first grooves 532. The second groove 542 is configured on a path of the second slot 541, and a second conductive plate 543 is received within the second groove 542. Therefore, the positive and negative electrode wiring ends of the heating wire ports 21 are able to penetrate the two through holes 511 provided on a side wall of the bas 51 and are respectively positioned between the first attachment means 53 and the second attachment means 54; in other words, the positive and negative electrode wirings of the heating wire ports 21 can be electrically connected to the first conductive plate 533 and the second conductive plate 543 respectively. Furthermore, the positive and negative electrode wiring ends of the external power line 7 can penetrate the two through holes 511 provided on another side wall of the base 51 and, similarly are respectively positioned between the first attachment means 53 and the second attachment means 54; in other words, the positive and negative wirings of the external power line 7 are respectively positioned within the first slot 531 and the second slot 541 on the other end thereof. The positive and negative electrode wiring ends of the external power line 7 are electrically connected to the first conductive plate 533 and the second conductive plate 543 respectively such that the heating wire ports 21 are electrically connected to the external power line 7 and such that the waterproof power connector box 5 provides a waterproof protection for the heating wire ports 21 to be electrically connected to the external power line 7. Furthermore, the positive and negative electrode wirings of the external power line 7 and the heating wire ports 21 can be further separated by the positive and negative electrode separation strip 534 of the first attachment means 53 such that short circuits of the external power line 7 and the heating wire ports 21 are prevented.

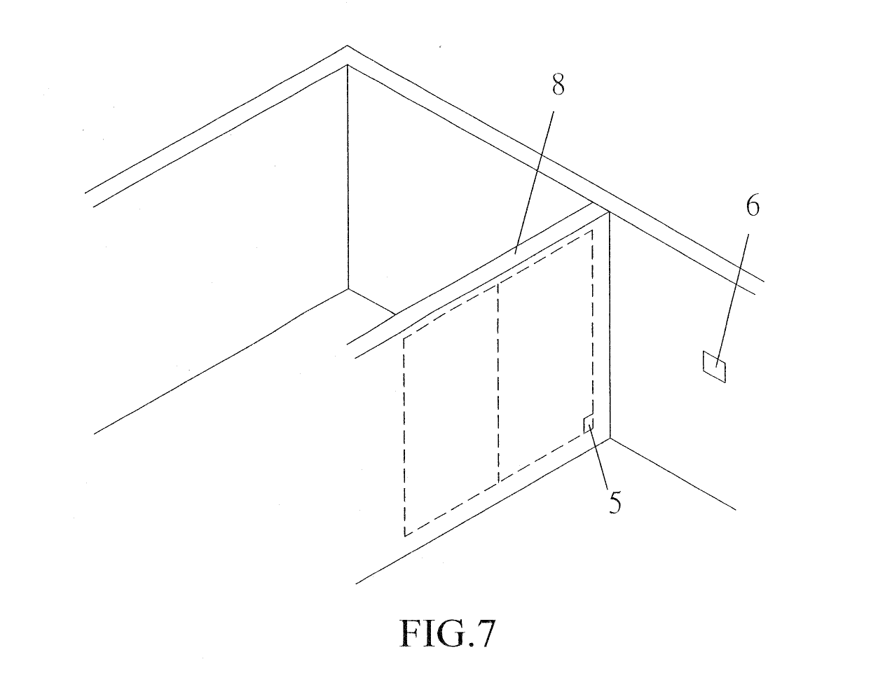

FIG. 7 shows a first exemplary embodiment of the present invention in an application of use, the heating module of the present invention can be attached to or received within an internal of an object 8. As the object 8 is a wall or partition, the heating module of the present invention (as shown by dashed line in the figure) can be received within an internal of the wall or partition such that the heat generated by the heat generating layer 2 thereof can be transferred to the heat conductive layer 3 that is capable of uniformly distributing the heat over the wall and partition. The heat can therefore be distributed from the internal of the wall or partition outward to the external thereof, requiring or occupying no excessive spaces, while being able to increase the room temperature in the surrounding.

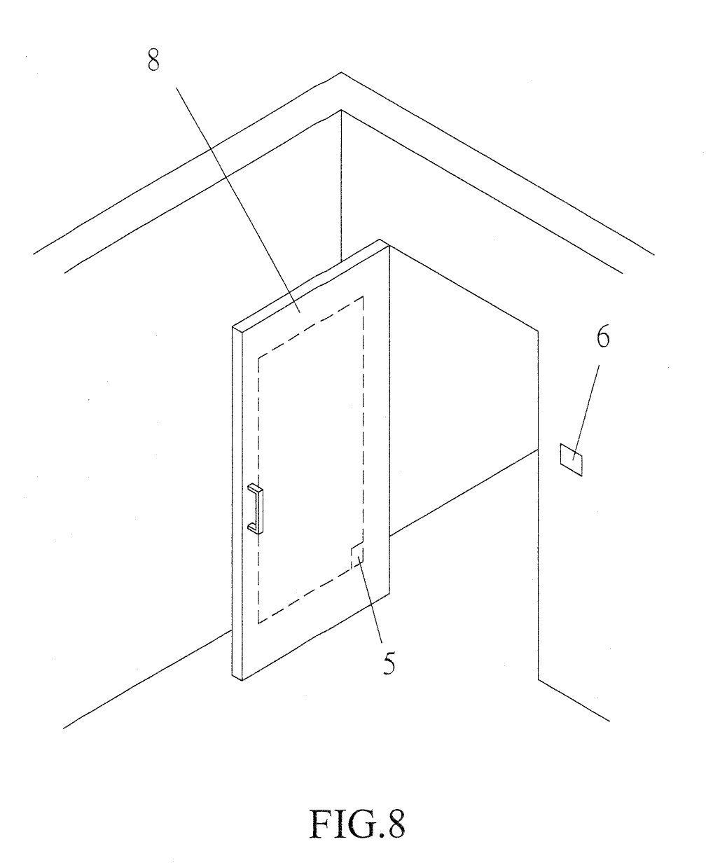

FIG. 8 shows a second exemplary embodiment of the present invention in an application of use, the heating module of the present invention can be attached to or received within an internal of an object 8. As the object 8 is a door piece, the heating module of the present invention (as shown by dashed line in the figure) can be received within an internal of the door piece such that the heat generated by the heat generating layer 2 thereof can be transferred to the heat conductive layer 3 that is capable of uniformly distributing the heat over the door piece. The heat can therefore be distributed from the internal of the door piece outward to the external thereof while being able to maintain the room at a certain temperature. The temperature controller 6 can be provided on the wall, allowing users to control the heat generating layer 2 to generate heat at a predetermined temperature via the temperature controller 6.

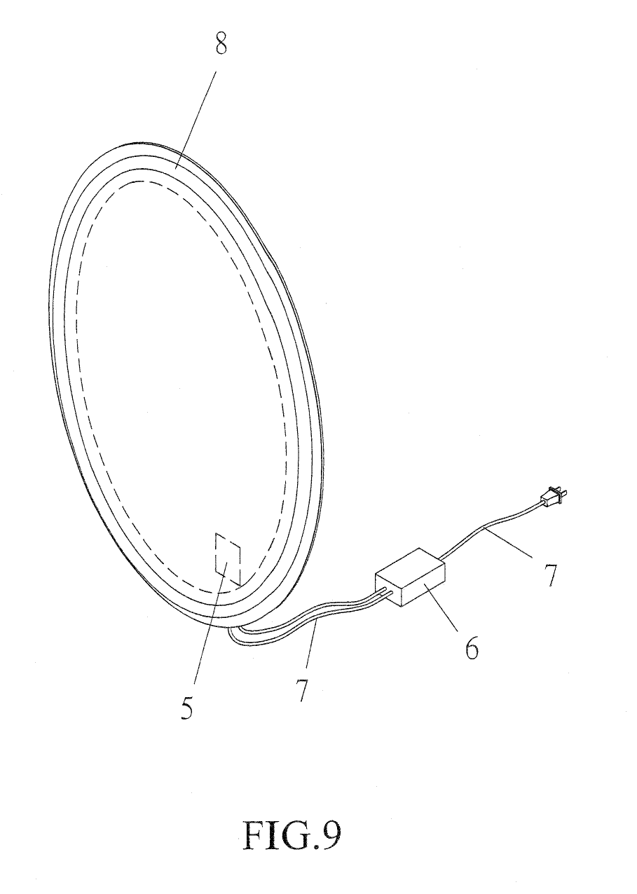

FIG. 9 shows a third exemplary embodiment of the present invention in an application of use, the heating module of the present invention can be attached to or received within an internal of an object 8. As the object 8 is a mirror, the heating module of the present invention (as shown by dashed line in the figure) can be attached to a backside of the mirror such that the heat generated by the heat generating layer 2 thereof can be transferred to the heat conductive layer 3 that is capable of uniformly distributing the heat over the mirror. The heat can therefore be distributed outward to the external of the mirror while being able to increase the room temperature in the surrounding.

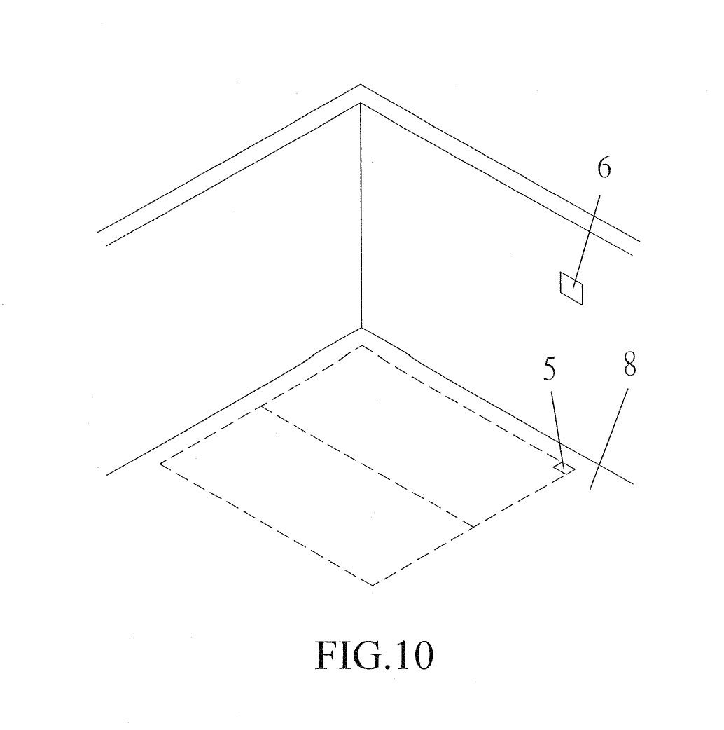

FIG. 10 shows a fourth exemplary embodiment of the present invention in an application of use, the heating module of the present invention can be attached to or received within an internal of an object 8. As the object 8 is a floor (or floor tile), the heating module of the present invention (as shown by dashed line in the figure) can be provided under the floor such that the heat generated by the heat generating layer 2 thereof can be transferred to the heat conductive layer 3 that is capable of uniformly distributing the heat over the floor. The heat can therefore be distributed from the internal of the floor or underground outward to the external thereof while being able to increase the room temperature in the surrounding.

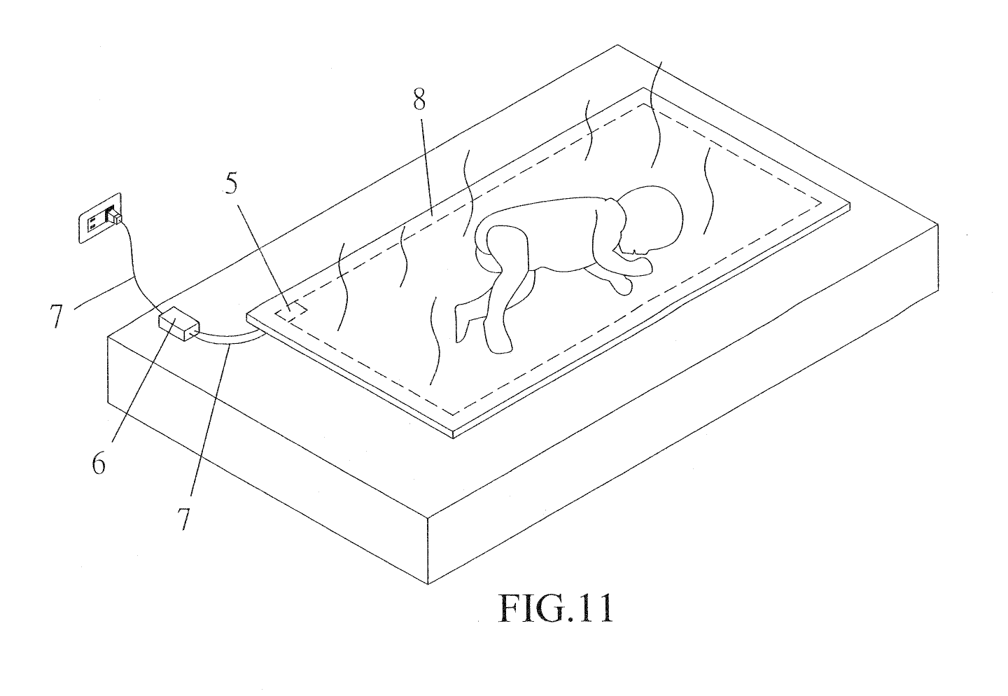

FIG. 11 shows a fifth exemplary embodiment of the present invention in an application of use, the heating module of the present invention can be configured and received within an internal of an object 8. As the object 8 is a mattress, the heating module of the present invention (as shown by dashed line in the figure) can be received within the mattress such that the heat generated by the heat generating layer 2 thereof can be transferred to the heat conductive layer 3 that is capable of uniformly distributing the heat over the mattress. The heat can therefore be distributed from the internal of the mattress outward to the external of thereof while being able to maintain the room or the bedding at a certain temperature.

The heat insulation layer 1, heat generating layer 2 and the heat conductive layer 3 can all be of the property of being flexible. As the heating module of the present invention exhibits flexibility, it can be rolled or bent in accordance with the shape of the object 8. Furthermore, the abovementioned first to fifth exemplary embodiments of the present invention in their application of uses are provided for illustrative purposes only and shall not be treated as limitations to the present invention. The outer part of the heating module of the present invention can also be covered or enclosed by other objects 8; said objects 8 include such as calcium silicate board, concrete board, glass, metals, fabrics, papers, silicon, rubber, tile, carpet, wood, stone, bamboo and other materials. Furthermore, the heating module of the present invention can be connected in series to form a multiple of heating modules (two or more) in accordance with the size of the object 8 to be attached to. By connecting each one of the external power line 7 of each one of the heating modules connected in multiple, in either series or parallel, as well as by connecting one of the external power line 7 extended out of the object 8 to the external power 7, every one of the heat generating layers 2 of the heating modules connected in multiple can then generate heat that may be of a greater or desirable magnitude.

What is claimed is:

1. A heating module attachable to an external object, said heating module comprising:
a heat insulation layer;
at least one heat generating layer provided on a top surface of said heat insulation layer, said heat generating layer comprises a heating wire port;
a heat conductive layer provided on top of said at least one heating layer such that said heating layer relatively positioned between said heat conductive layer and said heat insulation layer.

2. The heating module according to claim 1, further comprises at least two securing means; said securing means is provided between the heat generating layer and the heat conductive layer such that said heat generating layer is secured onto the top surface of the heat insulation layer via said securing means.

3. The heating module according to claim 1, wherein a bottom part of said heat conductive layer is coated with a heat dissipating paste attachable to the heat generating layer.

4. The heat module according to claim 1, wherein an outer part of said heat insulation layer is enclosed by an aluminum foil.

5. The heating module according to claim 1, further comprises a waterproof power connector box and a temperature controller; said heating wire port of the heat generating layer is electrically connected to an external power line via the waterproof power connector box; and said external power line is electrically connected to the temperature controller.

6. The heating module according to claim 5, wherein said waterproof power connector box comprises a base, a cover, a first attachment means and a second attachment means; said base comprises a receiving space, at least two through holes respectively provided on two parallel side walls of the base and opposing to each other and at least four fixations provided on the base; said cover is attached to and sealed on a top portion of the base, and said cover comprises at least four fixations corresponding to said fixations of the base; said first attachment means is received within the receiving space of the base; a surface of said first attachment means comprises two first slots and first grooves spaced apart from each other; said first groove is configured on a path of the first slot; and a first conductive plate is received within said first groove; said second attachment means is received within the receiving space and covers said surface of the first attachment means; a bottom surface of said second attachment means comprises two second slot sand second grooves spaced apart from each other; said second slot and second groove are arranged corresponding to said first slot and first groove; said second groove is configured on a path of the second slot; and a second conductive plate is received within the second groove.

7. The heating module according to claim 1, wherein said heat insulation layer, heat generating layer and heat conductive layer are of a property of being flexible.
